(19) United States
(12) Patent Application Publication
(10) Pub. No.: US 2018/0216529 A1
(43) Pub. Date: Aug. 2, 2018

(54) DEVICE FOR DE-ICING AN AIRCRAFT TURBOJET ENGINE NACELLE AIR INTAKE LIP

(71) Applicant: Safran Nacelles, Gonfreville L'Orcher (FR)

(72) Inventors: Hakim MAALIOUNE, Gonfreville L'Orcher (FR); Patrick GONIDEC, Gonfreville L'Orcher (FR); Jean-Paul RAMI, Gonfreville L'Orcher (FR)

(73) Assignee: Safran Nacelles, Gonfreville L'Orcher (FR)

(21) Appl. No.: 15/940,375

(22) Filed: Mar. 29, 2018

Related U.S. Application Data
(63) Continuation of application No. PCT/FR2016/052501, filed on Sep. 29, 2016.

(30) Foreign Application Priority Data
Sep. 29, 2015 (FR) 15/59184

(51) Int. Cl. F02C 7/047; B64D 15/04; B64D 33/02; B64D 15/06

(52) U.S. Cl. CPC F02C 7/047; B64D 15/04; B64D 33/02; F05D 2260/208; B64D 2033/0233; F05D 2220/323; B64D 15/06

(57) ABSTRACT

The present disclosure provides a device for de-icing an air intake lip of an aircraft turbojet engine nacelle. The de-icing device includes a de-icing circuit in which a heat transfer fluid, working in a two-phase form, circulates. The de-icing circuit includes at least one device for circulating the heat transfer fluid in the de-icing circuit, a system for heating the heat transfer fluid and configured to change the phase of the fluid to a vapor phase, and an inlet conduit that opens into the lip through a rear wall and injects the vapor phase fluid into the lip. The fluid changes phase when it condenses on the front wall of the lip to de-ice the lip.

### CROSS-REFERENCE TO RELATED APPLICATIONS

This application is a continuation of International Application No. PCT/FR2016/052501, filed on Sep. 29, 2016, which claims priority to and the benefit of FR 15/59184 filed on Sep. 29, 2015. The disclosures of the above applications are incorporated herein by reference.

### FIELD

The present disclosure relates to a device for de-icing an air intake lip of an aircraft turbojet engine nacelle.

### BACKGROUND

The statements in this section merely provide background information related to the present disclosure and may not constitute prior art.

An aircraft is propelled by one or more propulsion unit(s) comprising each a turbojet engine which is housed within a nacelle.

A nacelle has generally a substantially tubular structure which surrounds the turbojet engine and which comprises an air inlet upstream of the motor, a median section intended to surround a fan of said turbojet engine and a downstream section surrounding the combustion chamber of the turbojet engine and which can be equipped with thrust reversal means.

The air inlet comprises, on the one hand, an inlet lip adapted to allow the optimal collection toward the turbojet engine of the air necessary to the supply of the fan and of the internal compressors of the turbojet engine and, on the other hand, a downstream structure on which the lip is added which is intended to properly channel air toward the fan blades. The whole is attached upstream of a fan casing belonging to the median section of the whole.

In-flight, depending on the conditions of temperature, pressure and moisture, ice may be formed on the nacelle, in particular at the outer surface of the air inlet lip. The presence of ice or frost modifies the aerodynamic properties of the air inlet and disturbs the conveyance of air toward the fan.

A solution for de-icing or preventing frost from being formed on the outer surface consists of maintaining the concerned surface at a sufficient temperature according to the desired objective (melting of frost or total evaporation of water on the outer surface of the lip). Thus, it is widely known to take hot air at the turbojet engine compressor and bring it at the air inlet lip in order to warm the walls.

The lip and the front partition of the air inlet constitute a substantially toroidal enclosed volume called “D” shaped duct or lip duct (D-duct), in which hot de-icing air circulates in the concept of the state of the art mentioned herein.

However, this solution requires circulating air to a high temperature in the lip so as to ensure a thermal flow sufficient for de-icing, this air being conveyed by pipes whose mass is relatively high.

In addition, thermal protection elements are necessary to protect some parts from high heat, in particular those made of composite materials. These protections also add mass to the nacelle.

Finally, as previously described, the D-shaped duct is composed of the air inlet lip, whose outer face must be de-iced, and of the front partition of the air inlet which closes the rear part of the duct. This partition is not in contact with the outside air and is often overheated by de-icing air. The traditional hot air concept generates thus significant thermal overload.

### SUMMARY

The present disclosure provides a de-icing device for an air inlet lip of an aircraft turbojet engine nacelle, the lip forming a volume which is delimited by a front partition to be de-iced, forming a leading edge, and a rear partition, the device including a de-icing circuit in which circulates a heat transfer fluid which operates in two-phase form, the circuit comprising at least:

a reservoir that contains the heat transfer fluid;

a circulation device for the heat transfer fluid in the de-icing circuit which includes at least one circulation pump;

a heating system for the heat transfer fluid which is designed to bring said fluid into a vapor phase;

an inlet duct for the heat transfer fluid which opens into the lip, through the rear partition, to inject the vapor-phase heat transfer fluid inside the lip at a temperature close to its condensation point, the fluid changing in phase by condensing on the front wall of the lip to de-ice the lip; and

an outlet duct for the heat transfer fluid which opens into the lip, through the rear partition, to evacuate the heat transfer fluid out of the lip.

The present disclosure makes it possible to limit the temperature of the heat transfer fluid by injecting it into the lip at a temperature close to its condensation point.

This characteristic makes it possible to limit the risks of overheating on the lip and the surrounding structures and the thermal protections associated to the de-icing device.

The de-icing device makes it possible to replace hot air used in the state of the art by a gas having the ability to condense on the inner face of the air inlet. This phenomenon makes it possible to obtain a high thermal flow on the lip of the air inlet while staying at temperatures much lower than with “dry” air.

According to one aspect of the present disclosure, the inlet duct is arranged to inject the vapor-phase fluid inside the lip so that the fluid comes into direct contact with the front wall of the lip.

It is meant by temperature close to the fluid condensation point a temperature between the condensation point and 20 percent above the condensation point, the temperature being expressed in Kelvin.

According to one aspect of the present disclosure, the heat transfer fluid is for example a fluorinated organic compound whose condensation temperature is around 373K (at ambient atmospheric pressure).

According to another characteristic, the circulation device includes a turbine which is supplied with vapor-phase heat transfer fluid by an intake duct, and which drives the pump in motion.

This characteristic makes it possible to use the energy of the heat transfer fluid for driving in motion the circulation pump of the heat transfer fluid.

According to one variant, the circulation device includes a motor that drives the pump in motion.

According to another characteristic, the de-icing device is equipped with a regulation system which includes:

a central control unit; and

a temperature sensor which measures the temperature of the heat transfer fluid at the outlet of the heating system and communicates with the central control unit.

This characteristic makes it possible in particular to regulate the pressure and the temperature of the heat transfer fluid injected into the lip.

In one form, the regulation system includes a pressure relief valve which allows reducing the pressure in the de-icing circuit and in the lip.

Similarly, the regulation system includes a manometer for controlling the pressure in the lip which communicates with the central control unit.

According to one form, the regulation system includes a plurality of regulating valves which are adapted to regulate the pressure of the heat transfer fluid in the de-icing circuit and to regulate the pressure of the heat transfer fluid injected into the lip.

According to one form, the heating system includes an electric heater which is designed to heat the heat transfer fluid.

According to one form, the heating system includes a heat exchanger which is supplied with heated oil by the turbojet engine, and which is adapted to transfer thermal energy from said oil to the heat transfer fluid.

This characteristic makes it possible to heat the heat transfer fluid by the energy dissipated by the turbojet engine.

According to another characteristic, the reservoir is formed by a sump which is formed in a lower part of the lip, and which is adapted so that the heat transfer fluid flows under gravity into said reservoir, and in that that the outlet duct draws the liquid-phase heat transfer fluid into the reservoir for evacuating the heat transfer fluid contained in the lip.

According to one aspect of the present disclosure, a fan provides a circumferential circulation of the vapor-phase heat transfer fluid in the lip.

The present disclosure also concerns an aircraft turbojet engine nacelle equipped with a de-icing device according to any one of the preceding claims.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic perspective view illustrating a nacelle equipped with a simplified de-icing device, according to a first form of the present disclosure;

FIG. 2 is a schematic perspective view illustrating a de-icing device equipped with a regulation system, according to a second form of the present disclosure;

FIG. 3 is a schematic perspective view illustrating a de-icing device equipped with an oil to heat transfer fluid heat exchanger, according to a third form of the present disclosure;

FIG. 4 is a schematic perspective view illustrating a de-icing device equipped with a steam turbine, according to a fourth form of the present disclosure;

FIG. 5 is a schematic perspective detail view illustrating condensation of heat transfer fluid on an inner front wall of an air inlet lip; and

FIG. 6 is a schematic perspective detail view of a nacelle in accordance with the present disclosure, whose air inlet lip is equipped with a fan.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

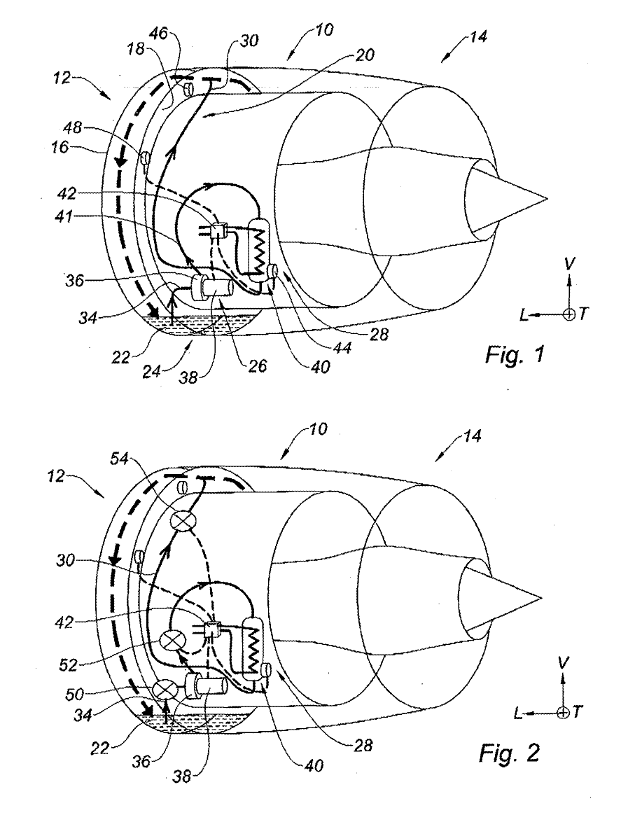

In the description and the claims, the terms “front” and “rear” will be used without limitation with reference to the front part and to the rear part respectively of FIGS. 1 to 6.

In addition, to clarify the description and the claims, the terminology longitudinal, vertical and transverse will be used without limitation with reference to the trihedron L, V, T indicated in the figures, whose axis L is parallel to the axis of the nacelle.

As used herein, the terms “upstream” and “downstream” should be understood in relation to the circulation of the heat transfer fluid inside the de-icing circuit.

Also, for the different variants, the same references may be used for elements that are identical or that provide the same function, for the sake of simplification of the description.

FIG. 1 shows a de-icing device 10 for an air inlet lip 12 of an aircraft turbojet engine nacelle 14.

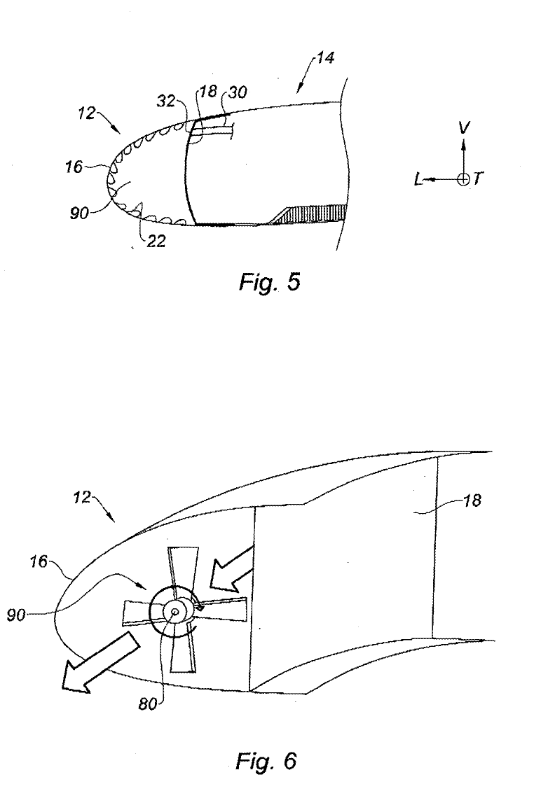

As can be seen in FIG. 5, the lip 12 forms a ring-shaped volume of a “D”-shaped 90 longitudinal section which is delimited by a front wall 16 to be de-iced, forming a leading edge, and a rear partition 18 which separates the volume delimited by the lip 12 and the segment of the nacelle which is connected to the lip 12.

As can be seen in FIGS. 1 to 6, the de-icing device 10 includes a de-icing circuit 20 in which circulates a heat transfer fluid 22 which operates in two-phase form, that is to say the heat transfer fluid 22 adopts two different phases, namely a liquid phase and a vapor phase.

The circuit 20 generally forms a closed loop which comprises the lip 12 and which allows circulating the heat transfer fluid 22 through the lip 12.

To this end, the circuit 20 comprises a reservoir 24 of heat transfer fluid 22, which is formed by a sump arranged in a lower part of the lip 12, so that the heat transfer fluid 22 flows under gravity toward the reservoir 24.

In addition, the de-icing circuit 20 includes a circulation device 26 for the heat transfer fluid 22, a heating system 28 for the heat transfer fluid 22, an inlet duct 30 for the heat transfer fluid 22 which opens into the lip 12, through the rear partition 18, to inject the vapor-phase heat transfer fluid 22 inside the lip 12, and an outlet duct 34 for the heat transfer fluid 22 which opens into the lip 12, through the rear partition 18, to evacuate the heat transfer fluid 22 outside the lip 12.

According to one variant not shown, the inlet duct 30 is connected to a plurality of inlet ports for injecting the heat transfer fluid in a distributed manner inside the lip 12.

According to a first form of the present disclosure shown in FIG. 1, the circulation device 26 for the heat transfer fluid 22 includes a circulation pump 36 which is supplied with heat transfer fluid 22 by the outlet duct 34 and which is driven by an electric motor 38.

According to whether the inlet duct 30 is immersed or not in the heat transfer fluid 22 contained in the reservoir 24, the circulation pump 36 is of the liquid or two-phase type with a gas to liquid separation capacity.

Still according to the first form, the heating system 28 includes an electric heater 40 which is designed to heat the heat transfer fluid.

In one variant, the electric heater 40 includes an electrical resistance which is mounted in a balloon in which the heat transfer fluid 22 circulates to bring the heat transfer fluid 22 from a liquid phase to a vapor phase.

As seen in FIG. 1, the electric heater 40 is connected to an outlet of the circulation pump 36 by a duct 41 to be supplied with liquid-phase calorific fluid 22, and an outlet of the electric heater 40 is connected to the lip 12 by the inlet duct 30 provided for this purpose.

In addition, the de-icing device 10 according to the first form is equipped with a regulation system that includes a central control unit 42, and a temperature sensor 44 which measures the temperature of the heat transfer fluid 22 at the outlet of the heating system 28, such as the outlet of the electric heater 40.

The temperature sensor 44 communicates with the central control unit 42 which regulates the temperature of the heat transfer fluid 22 by controlling the heater 40.

Similarly, the motor 38 of the circulation pump 36 is controlled by the central control unit 42 to regulate the suction pressure of the circulation pump 36 in the lip 12.

In addition, the regulation system includes a pressure relief valve 46 that allows reducing the pressure in the lip 12 in the event of excess pressure.

To this end, the pressure relief valve 46 is mounted on a wall of the lip 12, for example on the rear partition 18, to evacuate the vapor-phase calorific fluid 22 toward the outside of the lip 12.

Also, the regulation system includes a manometer 48 for controlling the pressure in the lip 12 which communicates with the central control unit 42, this characteristic enabling the central control unit 42 to regulate the pressure within the lip 12 by acting on the circulation pump 36 and on the heating system 28 of the heat transfer fluid 22.

The operation of the de-icing device 10 according to the first form is described below.

The heat transfer fluid 22 is drawn into the reservoir 24 by the circulation pump 36 through the outlet duct 34.

The circulation pump 36 makes the heat transfer fluid 22 circulate to the inlet of the electric heater 40 which raises the temperature of the heat transfer fluid 22 to a temperature allowing the fluid 22 to adopt a vapor phase.

The heat transfer fluid 22, still in the vapor phase, is injected into the lip 12 via the inlet duct 30, and the heat transfer fluid 22 condenses on the cold front wall 16 of the lip 12 to transmit its calories to the front wall 16, in order to de-ice the lip 12, as seen in FIG. 5.

Under gravity, the condensed liquid-phase heat transfer fluid 22 flows on the front wall 16 of the lip 12, to the reservoir 24 located at bottom of the lip 12.

According to this first form, the regulation of the pressure in the lip 12 is driven by the regulation of the motor speed 38 of the circulation pump 36 and by the regulation of the temperature of the electric heater 40.

Indeed, the more the suction generated by the circulation pump 36 is strong, the more the pressure in the lip 12 decreases, and the more the heater 40 temperature is high, the more the pressure and the de-icing temperature of the heat transfer fluid 22 increase.

FIG. 2 shows the de-icing device 10 according to a second form which differs from the de-icing device 10 according to the first form in that it includes a plurality of regulating valves.

According to the second form, the de-icing device 10 includes a first valve 50 for regulating the discharge of the pump circulation 36 toward the heating system 28, which is tapped onto the outlet duct 34, upstream of the pump 36, and a second valve 52 for regulating the discharge of the circulation pump 36 toward the heating system 28, which is tapped onto the duct 41 downstream of the circulation pump 36.

Thus, the first discharge regulating valve 50 and the second discharge regulating valve 52 allow regulating the pressure within the electric heater 40.

Complementarily, the de-icing device 10 includes a valve 54 for regulating the injection of the heat transfer fluid 22 into the lip 12, which is tapped onto the inlet duct 30, in order to regulate the injection pressure of the heat transfer fluid 22 injected into the lip 12.

To this end, the two discharge regulating valves 50, 52 and the injection regulating valve 54 are controlled by the central control unit 42.

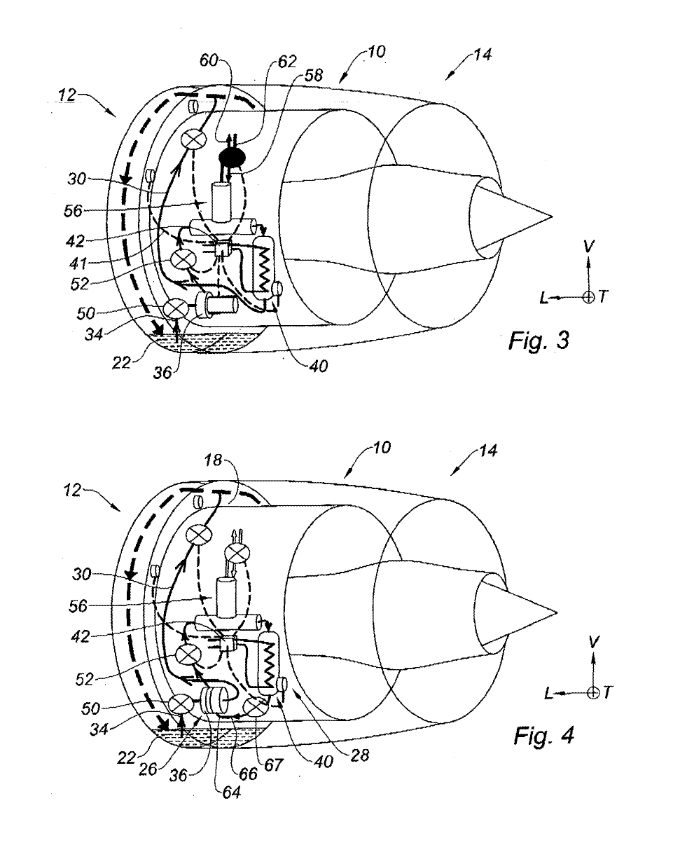

FIG. 3 shows the de-icing device 10 according to a third form which differs from the de-icing device 10 according to the second form in that the heating system 28 includes a heat exchanger 56 which is associated with the electric heater 40.

According to the third form, the heat exchanger 56 is supplied with oil heated by the motor (not shown) arranged in the nacelle 14, and which is adapted to transfer thermal energy from the oil to the heat transfer fluid 22.

According to one aspect, the heat exchanger 56 is arranged directly upstream of the electric heater 40.

In addition, a first oil supply duct 58 connects an inlet of the heat exchanger 56 to an oil supply source and a second discharge duct 60 connects an outlet of the exchanger 56, for allowing the flow of the oil through the heat exchanger 56.

In addition, a valve 62 controlled by the central control unit 42 regulates the motor oil flow rate which passes through the heat exchanger 56.

It should be noted that the temperature of the motor oil, according to one variant, is at least equal to the vaporization temperature of the heat transfer fluid 22, so that the heat exchanger 56 allows bringing the heat transfer fluid from a liquid phase to a vapor phase.

FIG. 4 shows the de-icing device 10 according to a fourth form which differs from the de-icing device 10 according to the third form in that the circulation device 26 includes a turbine 64 which is supplied with vapor-phase heat transfer fluid 22 by an intake duct 66 connected to the electric heater 40, and which drives the circulation pump 36 in motion.

Thus, before being injected into the lip 12, the vapor-phase heat transfer fluid 22 passes through the turbine 64, which operates as a steam engine.

As seen in FIG. 4, a regulating valve 67 is interposed between the electric heater 40 and the turbine 64, this valve being controlled by the central control unit 42.

The temperature of the heat transfer fluid 22 at the inlet of the turbine 64 will have to verify the following equation:

Tinlet=Tsat.(1+ε)+W/Cp

with Tinlet for the heat transfer fluid temperature at the inlet of the turbine 64 in degrees Kelvin, Tsat for the vaporization temperature of the heat transfer fluid 22 under the pressure conditions of the lip 12 in degrees Kelvin, ε for a margin coefficient, W for the power of the circulation pump 36 desired for the injection of the heat transfer fluid 22 into the lip 12 in Watt and Cp for the calorific coefficient at constant pressure of the heat transfer fluid 22.

This condition makes it possible to maintain a vapor phase at the outlet of the circulation pump 36 while injecting the heat transfer fluid 22 into the lip 12 at a temperature close to the condensation point, or dew point.

In steady-state, the energy migrates to the condensation areas whose condensation heat-transfer coefficient is in the order of 1200 to 1500 W/K.m² (unit in Watts per square meter Kelvin) while the gas-phase heat exchange hardly exceeds 300 W/K.m².

The temperature of the heat transfer fluid 22 is fixed by the dew point chosen in lip 12.

The rear partition 18 remains at a temperature substantially similar to the temperature of the vapor-phase heat transfer fluid 22 injected into the lip 12.

The temperature of the lip 12 remains equal to the condensation temperature of the heat transfer fluid 22 if the energy brought to the heat transfer fluid 22 is greater than the external drop vaporization energy, which verifies the following equation:

Q×DH=f×S

With S, in square meters, for the surface of the lip to be de-iced, f in Joule x meter/second for the flow to maintain on the front wall 16 to be de-iced in order to obtain the evaporation or the melting of frost according to the desired goal, Q in cubic meters/second for the flow rate of heat transfer fluid 22 to be injected and DH in Joule for the enthalpy of condensation which is substantially equal to the latent heat of evaporation of the heat transfer fluid 22 at the pressure prevailing in the lip 12.

It is thus notable that it is possible to de-ice the lip 12 provided that the flow rate of heat transfer fluid 22 is sufficient considering the latent heat of the heat transfer fluid 22.

It is therefore desired to use a fluid whose latent heat is the highest possible.

The de-icing device 10 according to the present disclosure has several advantages.

Indeed, the de-icing device 10 is self-regulating in temperature within the lip 12 as a function of the pressure in this area.

It is not necessary to monitor the temperature of the possible overheating areas.

If an area has no more droplets to be vaporized, its temperature stabilizes between the steam temperature and the condensation temperature of the heat transfer fluid 22.

The lip 12 and its environment cannot exceed the temperature of the injected vapor-phase heat transfer fluid 22 which is regulated by the heating system 28 and which is driven by the properties of the heat transfer fluid 22.

Therefore, no temperature sensor is necessary.

The quality of the condensation flow compensates for the need of temperature which may remain below 110 degrees Celsius or less, with much better efficiency than an air system or a Joule effect electrical system.

The heat energy of the motor oil is recovered by the phase-change heat exchanger 56 in an effective manner in most cases of aircraft flight.

In the descent phase, if the oil is not hot enough, the electric heater 40 can be used.

The electric heater 40 also makes it possible to overheat the heat transfer fluid 22 if the turbine 64 involves power, therefore an intake temperature, too high to be coming from the heat exchanger 56.

Thus, the present disclosure makes it possible to dispense with a heavy electrical resistance element and complex regulation.

If only the electrical energy is used to heat the heat transfer fluid 22, the electric heater has a compact volume in the order of one liter.

Also, the turbine and the pump are the only movable elements of the system with the valves.

The mass of the de-icing device 10 is substantially less than that of an aeraulic or electrical system, the flow of heat transfer fluid 22 being four times higher than that of air and the associated mass flow rate is four times lower for the same efficiency.

As shown in FIG. 6, it will be advantageously possible to add a fan 80 in the D-shaped duct 90 in order to make the fluid 22 circulate in the gas phase within this duct and to homogenize the thermal flow at the wall 16.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A de-icing device for an air inlet lip of an aircraft turbojet engine nacelle, the lip forming a volume delimited by a front wall to be de-iced, forming a leading edge, and a rear partition, the de-icing device including a de-icing circuit that circulates a heat transfer fluid that operates in two-phase form, the de-icing circuit comprising:
a reservoir containing the heat transfer fluid;
a circulation device operable to circulate the heat transfer fluid in the de-icing circuit, the circulation device including at least one circulation pump;
a heating system operable to heat the heat transfer fluid into a vapor phase;
an inlet duct configured to inject the vapor-phase heat transfer fluid into the lip through the rear partition of the lip, wherein the vapor-phase heat transfer fluid is at a temperature close to its condensation point when injected into the lip and the vapor-phase heat transfer fluid changing in phase by condensing on the front wall of the lip to de-ice the lip; and
an outlet duct configured to evacuate the heat transfer fluid out of the lip through the rear partition of the lip.

2. The de-icing device according to claim 1, wherein the circulation device includes a turbine that is supplied with vapor-phase heat transfer fluid via an intake duct and the turbine drives the at least one circulation pump in motion.

3. The de-icing device according to claim 1, wherein the circulation device includes a motor that drives the at least one circulation pump in motion.

4. The de-icing device according to claim 1 further comprising a regulation system, the regulation system comprising:
a central control unit; and
a temperature sensor that measures a temperature of the heat transfer fluid at an outlet of the heating system and communicates with the central control unit.

5. The de-icing device according to claim 4, wherein the regulation system includes a pressure relief valve operable to reduce pressure in the de-icing circuit and in the lip.

6. The de-icing device according to claim 4, wherein the regulation system includes a manometer for controlling pressure in the lip and communicating with the central control unit.

7. The de-icing device according to claim 4, wherein the regulation system includes a plurality of regulating valves adapted to regulate pressure of the heat transfer fluid in the de-icing circuit and regulate pressure of the heat transfer fluid injected into the lip.

8. The de-icing device according to claim 1, wherein the heating system includes an electric heater operable to heat the heat transfer fluid.

9. The de-icing device according to claim 1, wherein the heating system includes a heat exchanger supplied with oil heated by a turbojet engine, the heat exchanger adapted to transfer thermal energy from said oil to the heat transfer fluid.

10. The de-icing device according to claim 1, wherein the reservoir is formed by a sump arranged in a lower part of the lip such that the heat transfer fluid flows under gravity into said reservoir, wherein the outlet duct draws liquid-phase heat transfer fluid into the reservoir for evacuating the heat transfer fluid contained in the lip.

11. The de-icing device according to claim 1 further comprising a fan configured to circumferentially circulate the vapor-phase heat transfer fluid in the lip.

12. A nacelle for an aircraft turbojet engine comprising a de-icing device according to claim 1.
